(19) United States
(12) Patent Application Publication
(10) Pub. No.: US 2011/0081064 A1
(43) Pub. Date: Apr. 7, 2011

(54) IMAGE RECONSTRUCTION METHOD FOR DIFFUSE OPTICAL TOMOGRAPHY, DIFFUSE OPTICAL TOMOGRAPHY SYSTEM, AND COMPUTER PROGRAM PRODUCT

(75) Inventors: Yuan-Huang Hsu, Taipei City (TW); Wai-Chi Fang, Taichung City (TW); Tzu-Hsien Sang, Hsinchu City (TW)

(73) Assignee: NATIONAL CHIAO TUNG UNIVERSITY, Hsinchu (TW)

(21) Appl. No.: 12/755,965

(22) Filed: Apr. 7, 2010

(30) Foreign Application Priority Data
Oct. 6, 2009 (TW) 098133815

(51) Int. Cl. G06T 7/00

(52) U.S. Cl. 382/131

(57) ABSTRACT

An image reconstruction method for diffuse optical tomography is implemented using a diffuse optical tomography system, and includes the steps of: a) activating one of optical detecting units of the diffuse optical tomography system to emit a near-infrared ray to illuminate a target for outputting a received light signal corresponding to one of a plurality of sub-frames of the tomographic image of the target; b) obtaining a light intensity matrix based upon the received light signal; c) obtaining an absorption coefficient matrix corresponding to the one of the sub-frames based upon a product of the light intensity matrix and an inverse matrix of a weight matrix; d) repeating steps a) to c) with activating another one of the optical detecting units until the absorption coefficient matrices corresponding respectively to the sub-frames are obtained; and e) reconstructing the tomographic image of the target based upon the absorption coefficient matrices.

### CROSS-REFERENCE TO RELATED APPLICATION

This application claims priority of Taiwanese Application No. 098133815, filed on Oct. 6, 2009.

### BACKGROUND OF THE INVENTION

1. Field of the Invention

The present invention relates to an image reconstruction method, more particularly to an image reconstruction method for diffuse optical tomography.

2. Description of the Related Art

Diffuse optical tomography is a non-invasive medical imaging technique and uses a near-infrared optical source with a wavelength within 700 nm to 900 nm. When photons travel through a turbid medium having relatively great scattering coefficient (such as a human tissue), the photons are affected by scattering and absorption. Characteristics and direction of the photons will be changed after scattering, and light intensity will be decreased or the photons will disappear due to absorption. By the different distributions of near-infrared spectroscope within distinct biological tissues, the spatial and temporal change and absolute values of biological characteristics can be obtained, such as absorption coefficient, scattering coefficient, concentration of oxy-hemoglobin and concentration of de-oxy-hemoglobin.

One of conventional diffuse optical methods for obtaining tomographic images is a continuous wave imaging system proposed by A. Bozkurt et al. in “A portable near infrared spectroscopy system for bedside monitoring of newborn brain,” BioMedical Engineering OnLine, Vol. 4, page 29, 2005. The system proposed by A. Bozkurt has advantages of low cost, portability, low power consumption, and low computations.

However, prior to reconstruction of the tomographic images obtained using the continuous wave imaging system, it is required to use a diffusion equation for establishing a weight function corresponding to a particular biological tissue and a particular depth by simulating paths of the photons. In addition, medical imaging techniques generally require accuracy and high resolution. In order to obtain an image with high resolution, the calculations in the conventional techniques increase in complexity with enhancement of image resolution. During operation for tomographic image reconstruction, it is required to calculate an inverse solution to a large matrix, as described in “Imaging the body with diffuse optical tomography,” D. Boas et al., Signal Processing Magazine, IEEE, Vol. 18, pages 57-75, 2001.

Moreover, absorption coefficients and scattering coefficients of the human tissue result in difficulty in obtaining a tomographic image with high resolution and great accuracy. Therefore, an imaging system with reduced computations and relatively low implementation cost is desired.

### SUMMARY OF THE INVENTION

Therefore, an object of the present invention is to provide an image reconstruction method for diffuse optical tomography, and a diffuse optical tomography system configured to perform the image reconstruction method.

According to the present invention, an image reconstruction method for diffuse optical tomography to provide a tomographic image of a target is implemented using a diffuse optical tomography system that includes a plurality of optical detecting units. The image reconstruction method comprises the steps of:

a) configuring the diffuse optical tomography system to activate one of the optical detecting units to emit a near-infrared ray to illuminate the target, to receive a reflected light from the target, and to output a received light signal corresponding to one of a plurality of sub-frames of the tomographic image of the target;

b) configuring the diffuse optical tomography system to obtain a light intensity matrix based upon the received light signal originating from the activated one of the optical detecting units;

c) configuring the diffuse optical tomography system to obtain an absorption coefficient matrix corresponding to said one of the sub-frames based upon a product of the light intensity matrix and an inverse matrix that is previously obtained using singular value decomposition on a weight matrix previously obtained based upon a forward model;

d) repeating steps a) to c) with activating another one of the optical detecting units until the absorption coefficient matrices corresponding respectively to the sub-frames are obtained; and

e) configuring the diffuse optical tomography system to reconstruct the tomographic image of the target based upon the absorption coefficient matrices.

According to another aspect, a diffuse optical tomography system of the present invention comprises an optical detecting device, a processor, and a computing device.

The optical detecting device includes a plurality of optical detecting units. The processor is coupled to the optical detecting device, and is operable to control the optical detecting device and to obtain a light intensity matrix. The optical detecting device is controlled to activate one of the optical detecting units to emit a near-infrared ray to illuminate a target, to receive a reflected light from the target, and to output a received light signal corresponding to one of a plurality of sub-frames of a tomographic image of the target. Then, the processor is operable to obtain the light intensity matrix based upon the received light signal originating from the activated one of the optical detecting units.

The computing device includes a first computing unit and a second computing unit. The first computing unit is coupled to the processor for receiving the light intensity matrix therefrom, and is operable to multiply the light intensity matrix by an inverse matrix of a weight matrix to obtain an absorption coefficient matrix corresponding to one of the sub-frames. The second computing unit is operable to provide the tomographic image of the target.

Preferably, the optical detecting units are activated in turns for outputting respective received light signals that are used to obtain respective light intensity matrices. The first computing unit is operable to obtain a plurality of the absorption coefficient matrices corresponding respectively to the sub-frames. The second computing unit is operable to reconstruct the tomographic image based upon the absorption coefficient matrices.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram to illustrate a light source emitting a near-infrared ray to illuminate a target and a detector receiving a reflected light from the target;

FIG. 2 is a schematic diagram to illustrate an optical detecting array including a plurality of the light sources and the detectors for obtaining an absorption coefficient matrix corresponding to a cross-section;

FIG. 3 is a schematic diagram to illustrate a tomography image using different gray scales to indicate values of elements in the absorption coefficient matrix;

FIG. 4 is a block diagram of the preferred embodiment of a diffuse optical tomography system of the present invention;

FIG. 5 is a flow chart to illustrate an image reconstruction method for diffuse optical tomography implemented using the diffuse optical tomography system of FIG. 4;

FIG. 6 is a block diagram of an inverse solution module of the diffuse optical tomography system;

FIGS. 7a and 7b are tomographic images of a first medium using a frame mode for image reconstruction;

FIGS. 8a and 8b are tomographic images of the first medium using a sub-frame mode for image reconstruction;

FIGS. 9a and 9b are tomographic images of a second medium using the frame mode for image reconstruction; and

FIGS. 10a and 10b are tomographic images of the second medium using the sub-frame mode for image reconstruction.

### DETAILED DESCRIPTION OF THE PREFERRED EMBODIMENT

First, it should be noted that an image reconstruction method for diffuse optical tomography and a diffuse optical tomography system of the present invention are applied to a near-infrared spectroscopy imaging system in the following disclosed preferred embodiment. However, the method and the system can also be applied to other tomography systems using a diffuse optical source in practice.

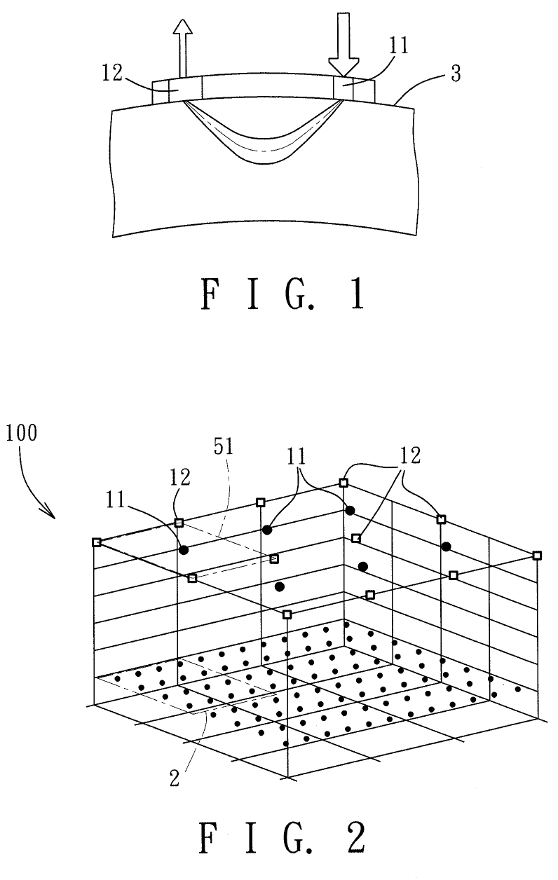

FIG. 1 shows diffusion photons passing through a target 3 that is a predetermined area of a human tissue, such as a brain. Alight source 11 emits a near-infrared ray to illuminate a target 3, and a detector 12 receives a reflected light from the target 3.

The human tissue contains cells and blood vessels with different absorption coefficients. Referring to FIG. 2, in order to obtain an absorption coefficient matrix corresponding to a cross-section 2 of the target 3, a diffuse optical tomography system of the preferred embodiment employs an optical detecting array 100 including a plurality of the light sources 11 and the detectors 12. Each of the light sources 11 is surrounded by four of the detectors 12, and a combination of one of the light sources 11 and the surrounding four of the detectors 12 serves as an optical detecting unit 51. That is to say, the optical detecting array 100 of FIG. 2 includes six optical detecting units 51 since there are six light sources 11 in the optical detecting array 100. Moreover, the diffuse optical tomography system of this embodiment is operable in a time division manner, i.e., the optical detecting units 51 of the optical detecting array 100 are activated in turns for emitting the near-infrared ray and receiving the reflected light.

Light intensity of the reflected light received by one of the optical detecting units 51 can be expressed as a light intensity matrix b, a weight matrix corresponding to the position of the cross-section 2 can be expressed as A, and the absorption coefficient matrix corresponding to the cross-section 2 is denoted as X. Further, the relationship among the light intensity matrix b, the weight matrix A, and the absorption coefficient matrix X can be expressed as b=AX. Since the light intensity matrix b can be obtained using the corresponding one of the optical detecting units 51, and the weight matrix A corresponding to the position of the cross-section 2 can be obtained based upon a pre-determined mathematical model, such as a forward model, the unknown absorption coefficient matrix X can be expressed as X=A⁻¹b. Regarding the above-mentioned equation, since the light intensity matrix b and the weight matrix A are known, the absorption coefficient matrix X can be obtained once the inverse matrix A⁻¹ of the weight matrix A is obtained by inverse solution.

Since the inverse solution is a difficult problem in image reconstruction, a selected method for the inverse solution is critical. In this embodiment, for stability and reliability, Jacobi Singular Value Decomposition (JSVD) is used for the inverse solution. JSVD is capable of parallel computation, and can be implemented using extra large scale integrated circuit. The inverse matrix A⁻¹ of the weight matrix A can be obtained using JSVD, and the light intensity matrix b is known. Thus, the absorption coefficient matrix X can be obtained based upon X=A⁻¹b.

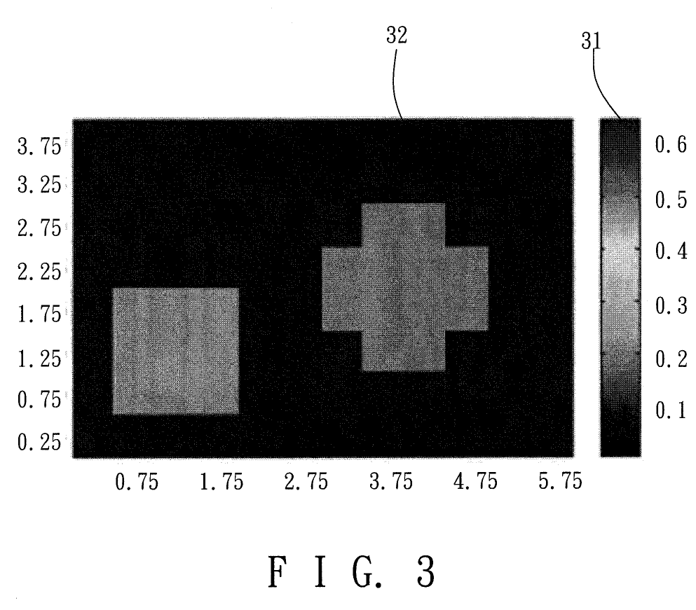

In this embodiment, as shown in FIG. 3, by using different gray scales to indicate values of elements in the absorption coefficient matrix X according to a reference scale 32, a diffuse tomographic image 32 of the cross-section 2 can be obtained. When the tissues in a certain area are all homogeneous media, the diffuse tomographic image 32 is indicated in a single gray scale. When a non-homogeneous tissue exists in the certain area, a variation in gray scales is presented in the diffuse tomographic image 32 at a position corresponding to the non-homogeneous tissue. Thus, it can be appreciated that the corresponding position may indicate an abnormal condition.

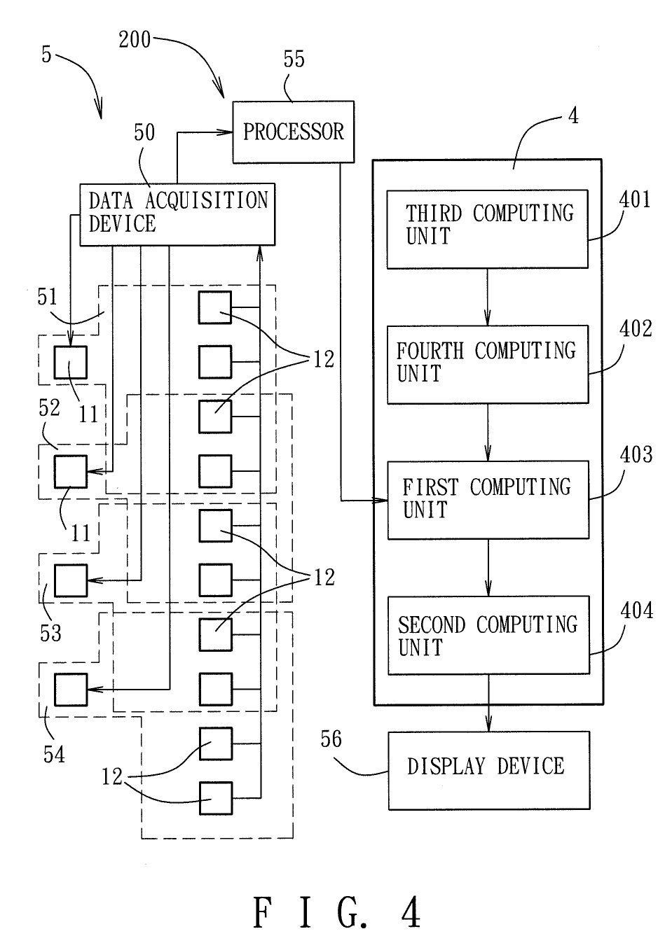

Referring to FIG. 4, a diffuse optical tomography system 200 of the preferred embodiment includes an optical detecting device 5, a processor 55, a computing device 4, and a display device 56. In this embodiment, the optical detecting device 5 includes a data acquisition device 50 and four sets of optical detecting units 51 to 54. Each of the optical detecting units 51 to 54 is constructed from one light source 11 and four detectors 12 that surround the light source 11. The processor 55 is coupled to the optical detecting device 5, and is operable to control the data acquisition device 50 to activate the optical detecting units 51 to 54 in turns.

The function of the computing device 4 can be implemented using program instructions or hardware. Regarding the program instructions, a computer program product comprises a machine readable storage medium that includes the program instructions for configuring a computer to perform consecutive steps of an image reconstruction method for diffuse optical tomography.

Regarding the hardware, the computing device 4 includes a first computing unit 403 and a second computing unit 404. The first computing unit 403 is coupled to the processor 55 for receiving the light intensity matrix b therefrom, and is operable to multiply the light intensity matrix b by the inverse matrix A⁻¹ of the weight matrix A to obtain the absorption coefficient matrix X corresponding to one of the sub-frames. The second computing unit 404 is operable to provide the tomographic image of the target. The computing device 4 further includes a third computing unit 401 operable to obtain the weight matrix A based upon the forward model, and a fourth computing unit 402 operable to obtain the inverse matrix A⁻¹ of the weight matrix A using JSVD.

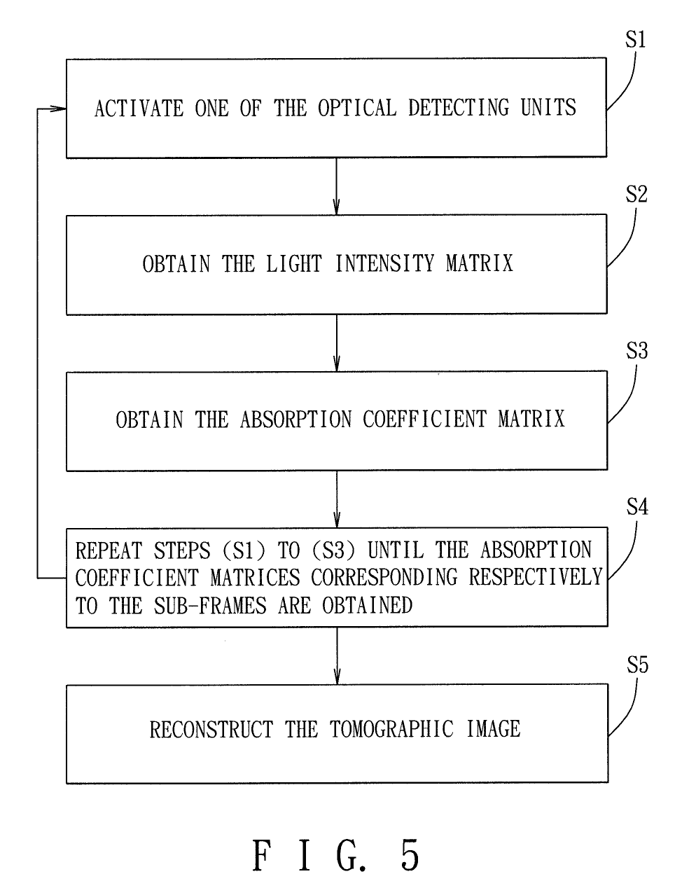

FIG. 5 illustrates a flow chart of the image reconstruction method implemented using the diffuse optical tomography system 200 shown in FIG. 4. In step (S1), the processor 55 is operable to control the data acquisition device 50 to activate one of the optical detecting units 51 to 54. The light source 11 of the activated one of the optical detecting units 51 to 54 emits the near-infrared ray to illuminate a target, and the detectors 12 receive the reflected light from the target. Then, the data acquisition device 50 outputs a received light signal corresponding to one of a plurality of sub-frames of a tomographic image of the target.

In step (S2), the processor 55 is further operable to receive the received light signal, and to obtain the light intensity matrix b based upon the received light signal. In step (S3), the first computing unit 403 receives the light intensity matrix b from the processor 55, and is operable to obtain the absorption coefficient matrix X corresponding to the one of the sub-frames based upon a product of the light intensity matrix b and the inverse matrix A⁻¹ of the weight matrix A.

In step (S4), the diffuse optical tomography system 200 is configured to repeat steps (S1) to (S3) with activating another one of the optical detecting units until the absorption coefficient matrices X corresponding respectively to the sub-frames are obtained. Then, in step (S5), the second computing unit 404 is operable to reconstruct the tomographic image based upon the absorption coefficient matrices X obtained in step (S3).

Regarding the weight matrix A, the forward model can be used for computing the weight matrix A corresponding to different positions. In the diffuse optical tomography system 200 including i light sources 11 and j detectors 12, the light intensity matrix b can be expressed as Equation (1).

$$b = [ \begin{matrix}{Φ}_{( scat , 1 )} ( {r}_{s 1} , {r}_{d 1} ) \\ {Φ}_{( scat , 2 )} ( {r}_{s 2} , {r}_{d 2} ) \\ ⋮ \\ {Φ}_{( scat , m )} ( {r}_{si} , {t}_{dj} )\end{matrix} ] = AX = [ \begin{matrix}{a}_{11} & {a}_{12} & ⋯ & {a}_{1 n} \\ {a}_{21} & {a}_{22} & ⋯ & {a}_{2 n} \\ ⋮ & ⋮ & ⋱ & ⋮ \\ {a}_{m 1} & {a}_{m 2} & ⋯ & {a}_{mn}\end{matrix} ] [ \begin{matrix}{Δμ}_{a} ( {r}_{1} ) \\ {Δμ}_{a} ( {r}_{2} ) \\ ⋮ \\ {Δμ}_{a} ( {r}_{n} )\end{matrix} ] \qquad ( 1 )$$

In Equation (1), Φ_{(scat,m)}(rₛᵢ,r_{dj}) is the light intensity at position (rₛᵢ,r_{dj}), aₘₙ is a weighting function in different locations, and Δμₐ(rₙ) is the change of the absorption coefficient of each observed voxel.

In this embodiment, the weight matrix A in different locations can be resolved using Rytov approximation upon the photon diffusion equation. For example, T. J. Farrell et al. proposed the resolution of the weight matrix A using Rytov approximation in “A diffusion theory model of spatially resolved, steady-state diffuse reflectance for the noninvasive determination of tissue optical properties in vivo,” Med. Phys., Vol. 19, page 879, 1992.

Regarding the inverse solution for obtaining the inverse matrix A⁻¹ of the weight matrix A, singular value decomposition (SVD) is used for analyzing the elements in the matrix. Through SVD, the weight matrix A can be decomposed into three matrices as in the following Equation (2).

A_{m×n}=U_{m×m}D_{m×n}V_{n×n}^{T}

A_{n×m}⁻¹=U_{m×m}^{T}A_{m×n}V_{n×n}=D_{m×n} (2)

In Equation (2), columns of the matrices U and V are eigenvectors of the AA^{T} and A^{T}A, and diagonal elements of the matrix D are singular values of the matrix A. Particularly, the matrix U is a column-orthogonal matrix, and the matrix D is a diagonal matrix.

In this embodiment, JSVD is used for the inverse solution. JSVD can be implemented by a field programmable gate array (FPGA) with systolic array circuits as proposed by W. Ma, M. Kaye, et al. in “An FPGA-based singular value decomposition processor,” Electrical and Computer Engineering, Canadian Conference on, pages 1047-1050, 2006.

Moreover, Jack E. Volder introduced a coordinate rotation digital computer (CORDIC) algorithm for calculating trigonometric functions by vector rotation in 1959. The CORDIC algorithm is derived from the general rotation transform which rotates a vector in a Cartesian plane by an angle θ. Hardware for implementing CORDIC algorithm has been proposed by J. Cavallaro, et al. in “CORDIC Arithmetic for an SVD Processor,” Journal of parallel and distributed computing, Vol. 5, pages 271-290, 1988.

The following Equations (3) to (6) can be obtained according to “FPGA based singular value decomposition for image processing application,” M. Rahmati, et al., Application-Specific Systems, Architecture and Processors, pages 185-190, 2008.

$$\begin{matrix}{( {J}_{i}^{l} )}^{T} {A}_{i} {J}_{- i}^{r} = {A}_{i + 1} & ( 3 ) \\ {D}_{i} = {A}_{i} = {( {J}_{i}^{l} )}^{T} {( {J}_{i - 1}^{l} )}^{T} ⋯ {( {J}_{0}^{l} )}^{T} {A}_{0} {J}_{0}^{r} ⋯ {J}_{i - 1}^{r} {J}_{i}^{r} & ( 4 ) \\ {[ \begin{matrix}cos {θ}_{l} & sin {θ}_{l} \\ - sin {θ}_{l} & cos {θ}_{l}\end{matrix} ]}^{T} [ \begin{matrix}{a}_{pp} & {a}_{pq} \\ {a}_{qp} & {a}_{qq}\end{matrix} ] [ \begin{matrix}cos {θ}_{r} & sin {θ}_{r} \\ - sin {θ}_{r} & cos {θ}_{r}\end{matrix} ] = [ \begin{matrix}{σ}_{1} & 0 \\ 0 & {σ}_{2}\end{matrix} ] & ( 5 ) \\ J ( p , q , θ ) = [ \begin{matrix}1 & ⋯ & 0 & ⋯ & 0 & ⋯ & 0 \\ ⋮ & ⋱ & ⋮ & & ⋮ & & ⋮ \\ 0 & ⋯ & cos {θ}_{pp} & ⋯ & sin {θ}_{pq} & ⋯ & 0 \\ ⋮ & & ⋮ & ⋱ & ⋮ & & ⋮ \\ 0 & ⋯ & - sin {θ}_{qp} & ⋯ & cos {θ}_{qq} & ⋯ & 0 \\ ⋮ & & ⋮ & & ⋮ & & ⋮ \\ 0 & ⋯ & 0 & ⋯ & 0 & ⋯ & 1\end{matrix} ] & ( 6 )\end{matrix}$$

In Equations (3) and (4), Jᵢ is a Jacobi rotation matrix generated by eliminating off-diagonal elements of the matrix A as expressed in Equation (6). Each time of iteration will make the matrix Aᵢ₊₁ more diagonal than Aᵢ. Considering a 2×2 matrix A and comparing Equations (2) and (5), the matrix U^{T} is

$${[ \begin{matrix}cos {θ}_{l} & sin {θ}_{l} \\ - sin {θ}_{l} & cos {θ}_{l}\end{matrix} ]}^{T} ,$$

the matrix V is

$$[ \begin{matrix}cos {θ}_{r} & sin {θ}_{r} \\ - sin {θ}_{r} & cos {θ}_{r}\end{matrix} ] ,$$

and the matrix A is

$$[ \begin{matrix}{a}_{pp} & {a}_{pq} \\ {a}_{qp} & {a}_{qq}\end{matrix} ] .$$

Therefore, the matrix A⁻¹ is

$$[ \begin{matrix}{σ}_{1} & 0 \\ 0 & {σ}_{2}\end{matrix} ] .$$

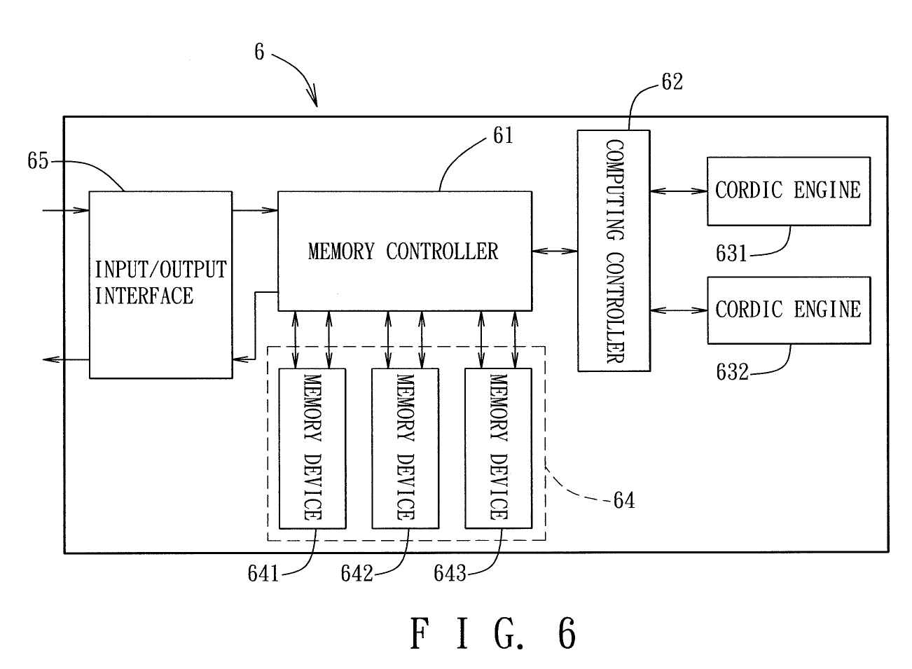

Referring to FIGS. 4 and 6, the fourth computing unit 402 is an inverse solution module 6 that includes an input/output interface 65, a memory module 64, a memory controller 61 coupled between the input/output interface 65 and the memory module 64, two CORDIC engines 631 and 632, and a computing controller 62 coupled between the memory controller 61 and the CORDIC engines 631, 632. The memory module 64 includes a plurality of memory devices 641, 642, 643 each of which is a dual port memory cooperating with the CORDIC engines 631, 632 for parallel processing.

The input/output interface 65 is operable to receive the weight matrix A from the third computing unit 401 and to output the inverse matrix A⁻¹ of the weight matrix A. The memory controller 61 is operable to store the weight matrix A in the memory module 64 and to access the weight matrix A stored in the memory module 64. The computing controller 62 is operable to receive the weight matrix A from the memory controller 61, to output the weight matrix A to the CORDIC engines 631, 632, and to control parallel processing of the CORDIC engines 631, 632 for decomposing the weight matrix A to obtain decomposed matrices U^{T}, V, D from the weight matrix A. The memory devices 641-643 of the memory module 64 are operable to store the decomposed matrices U^{T}, V and D, respectively.

The CORDIC engines 631, 632 are operable to obtain the cos θᵣ, sin θᵣ, cos θₗ, sin θₗ, according to an algorithm in Table 1. Then, the CORDIC engines 631, 632 are operable to obtain the matrices U^{T} and V based upon the cos θᵣ, sin θᵣ, cos θₗ, sin θₗ, and to obtain the weight matrix A according to Equations (3) to (6). Therefore, the inverse matrix A⁻¹ of the weight matrix A can be obtained. A detailed description of the procedure for obtaining inverse matrix A⁻¹ of the weight matrix A is provided in a thesis, “Novel Image Reconstruction Algorithm and System-on-Chip Design for Continuous-wave Diffuse Optical Tomography Systems,” submitted to Department of Electronics Engineering & Institute of Electronics, College of Electrical and Computer Engineering, National Chiao Tung University, Taiwan.

TABLE 1

| | | CORDIC Engine 1 | CORDIC Engine 2 |
|---|---|---|---|
| Stage | Input | x = d − a; y = b + c; z = 0 | x = d + a; y = b − c; z = 0 |
| 1 | | Mode: vectoring | Mode: vectoring |
| | Output | zₙ = θₛᵤₘ = tan⁻¹(d − a/b + c) | zₙ = θ_{diff} = tan⁻¹(d + a/c − b) |
| Stage | Input | x = a; y = b; | x = c; y = d; |
| 2 | | z = θᵣ = (θₛᵤₘ + θ_{diff})/2 | z = θᵣ = (θₛᵤₘ + θ_{diff})/2 |
| | | Mode: rotation | Mode: rotation |
| | Output | $\begin{matrix}{A}_{1} = A \times R ( {θ}_{r} ) = [ \begin{matrix}{a}_{1} & {b}_{1} \\ {c}_{1} & {d}_{1}\end{matrix} ] \\ R ( {θ}_{r} ) is the rotation matrix .\end{matrix}$ | |
| Stage | Input | x = a; y = b; | x = b₁; y = d₁; |
| 3 | | z = θᵣ = (θₛᵤₘ + θ_{diff})/2 | z = θᵣ = (θₛᵤₘ + θ_{diff})/2 |
| | | Mode: rotation | Mode: rotation |
| | Output | $\begin{matrix}{R}^{T} ( {θ}_{1} ) \times {M}_{1} = [ \begin{matrix}{ϕ}_{1} & 0 \\ 0 & {ϕ}_{3}\end{matrix} ] \\ R ( {θ}_{1} ) is the rotation matrix .\end{matrix}$ | |
| Stage | Input | x = 1; y = 0; z = θᵣ | x = 1; y = 0; z = θᵣ |
| 4 | | Mode: rotation | Mode: rotation |
| | Output | xₙ = cos(θᵣ),yₙ = sin(θᵣ) | xₙ = cos(θₗ),yₙ = sin(θᵣ) |

The circuit of the computing controller 62 is implemented using hardware description language in Verilog. Although a main goal of the computing controller 62 is not processing speed, the processing speed thereof can reach 200 MHz. The fix-point JSVD can decompose a 16×16 matrix and offer 14-bit precision CORDIC engines. It only takes 160 μs to implement an iteration of a 4×16 matrix.

In order to simplify operation, a truncated SVD (TSVD) algorithm that is a way to retain the t numbers of biggest non-zero singular values in a matrix is introduced. The t is referred to as a truncated parameter. Two modes of inverse operations are proposed; one is called the frame mode and the other is called the sub-frame mode. For a tomographic image containing 96 voxel within an area of (4×6)cm², the tomographic image with 96 voxel is reconstructed directly in the frame mode. Thus, there are in total 96 numbers of the absorption coefficients that have to be solved in one system of linear equations. However, the frame of the tomographic image can be divided into six sub-frames with 4×4 voxels in the sub-frame mode. In this way, six relatively smaller inverse problems are solved instead of solving one big problem.

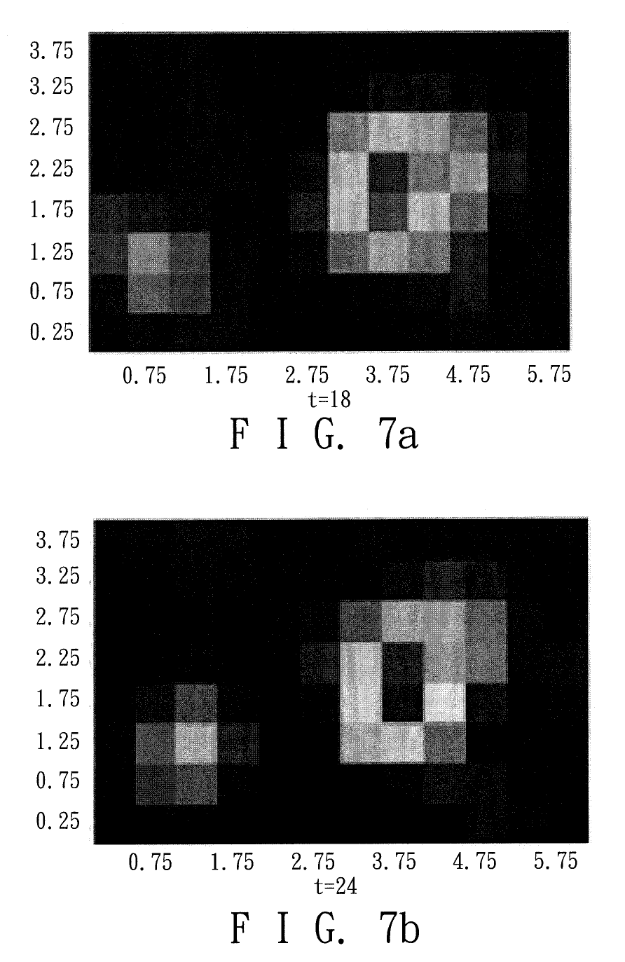

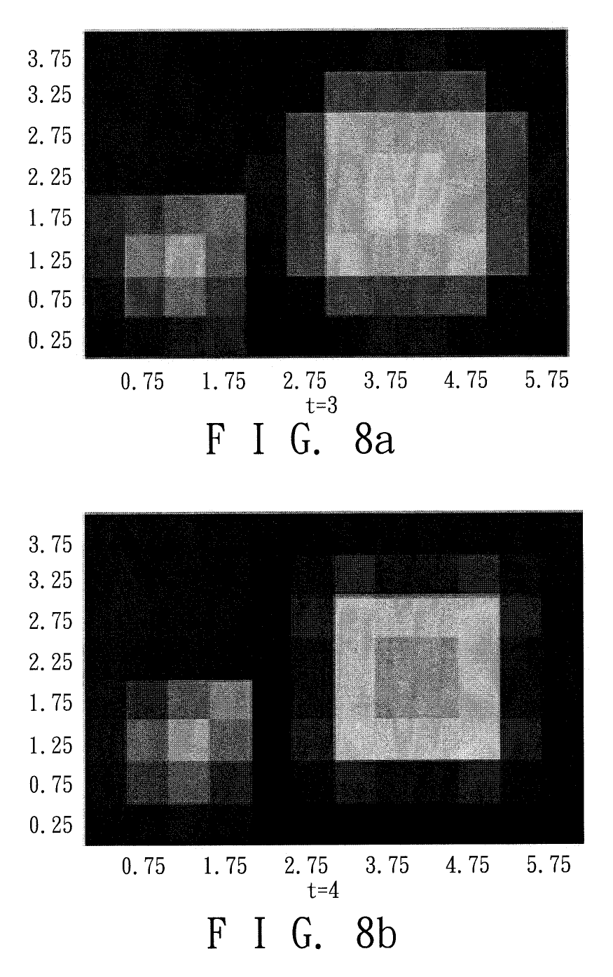

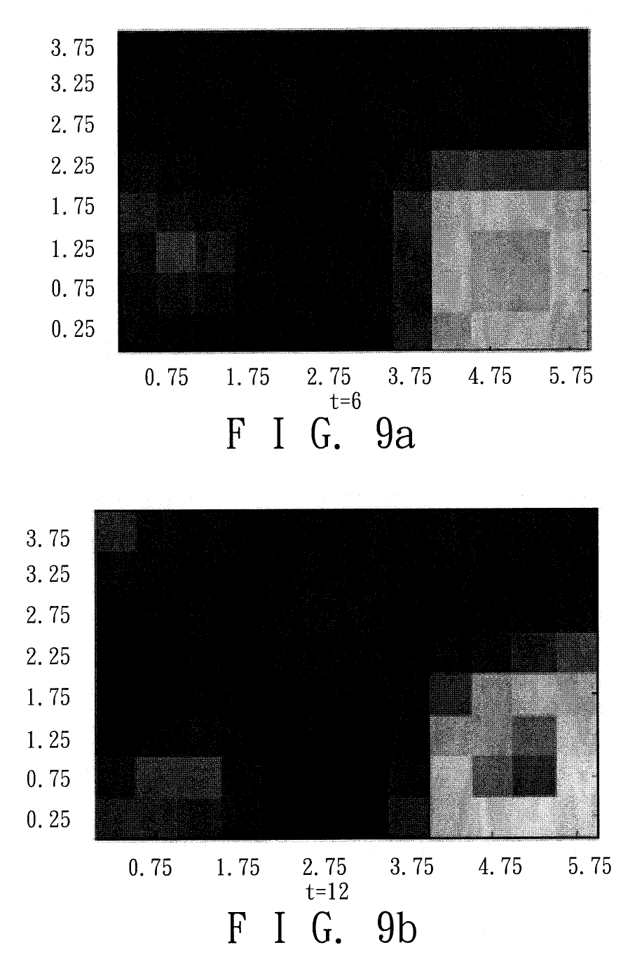

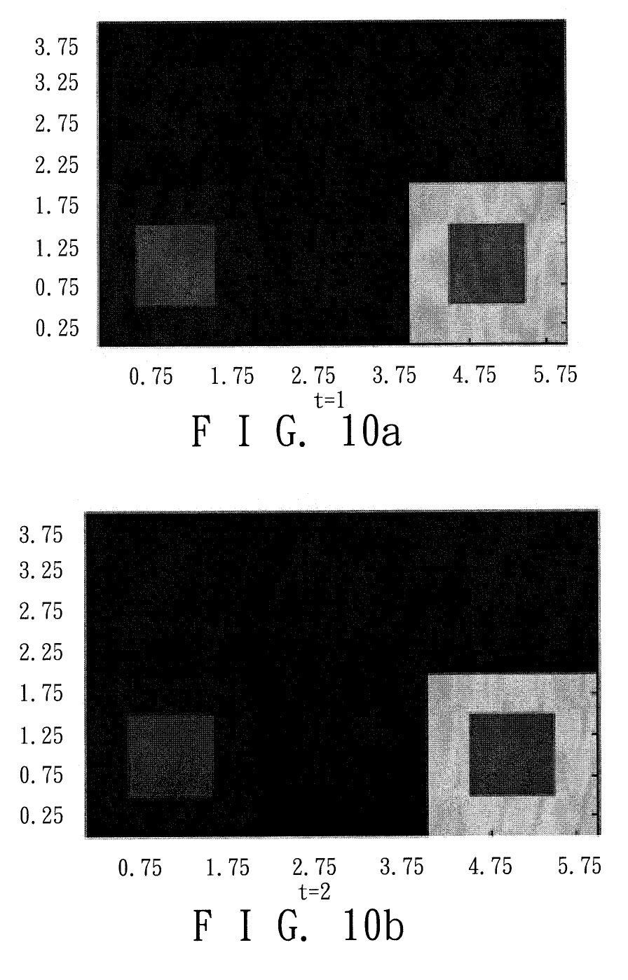

FIGS. 7a and 7b show the tomographic images of a first medium using the frame mode with various truncated numbers t for image reconstruction, and FIGS. 8a and 8b show the tomographic images of the first medium using the sub-frame mode for image reconstruction. In a second medium, all the non-homogeneous tissues are located in the sub-frames, and the tomographic images of the second medium are shown in FIGS. 9a, 9b, 10a and 10b.

Mean square error (MSE) and computational time in the two modes for the first and second mediums are shown in Table 2 and Table 3. It can be appreciated that the computational time of the frame mode is about two hundred times more than the computational time of the sub-frame mode due to the large matrix solved by iteration of JSVD in the frame mode. Moreover, since the non-homogeneous tissues are near the center of the sub-frame in the second medium, MSE of the sub-frame mode is smaller than the MSE of the frame mode, and image quality of the sub-frame mode is also relatively better.

TABLE 2

| | Frame mode | | | |
|---|---|---|---|---|
| | First medium | | Second medium | |
| Truncate | Computational | MSE | Computational | MSE |
| parameter | time (sec) | (×10⁻⁴) | time (sec) | (×10⁻⁴) |
| 24 | 5.780064 | 86 | 6.326128 | 176 |
| 18 | 5.687689 | 80 | 5.507522 | 129 |
| 12 | 5.456757 | 66 | 5.318873 | 81 |
| 6 | 5.421226 | 178 | 5.372787 | 81 |

TABLE 3

| | Subf-Frame mode | | | |
|---|---|---|---|---|
| | First medium | | Second medium | |
| Truncate | Computational | MSE | Computational | MSE |
| parameter | time (sec) | (×10⁻⁴) | time (sec) | (×10⁻⁴) |
| 4 | 0.034519 | 99 | 0.034079 | 78 |
| 3 | 0.034326 | 149 | 0.040209 | 78 |
| 2 | 0.034536 | 202 | 0.033942 | 78 |
| 1 | 0.034241 | 252 | 0.040864 | 78 |

In summary, the sub-frame mode is proposed in order to reduce computational complexity of the matrices. Further, the SVD algorithm for the inverse solution facilitates the design of the hardware and application to a portable device. Therefore, the objects of the present invention can be certainly achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An image reconstruction method for diffuse optical tomography to provide a tomographic image of a target, said image reconstruction method to be implemented using a diffuse optical tomography system that includes a plurality of optical detecting units, said image reconstruction method comprising the steps of:
a) configuring the diffuse optical tomography system to activate one of the optical detecting units to emit a near-infrared ray to illuminate the target, to receive a reflected light from the target, and to output a received light signal corresponding to one of a plurality of sub-frames of the tomographic image of the target;
b) configuring the diffuse optical tomography system to obtain a light intensity matrix based upon the received light signal originating from the activated one of the optical detecting units;
c) configuring the diffuse optical tomography system to obtain an absorption coefficient matrix corresponding to said one of the sub-frames based upon a product of the light intensity matrix and an inverse matrix that is previously obtained using singular value decomposition on a weight matrix previously obtained based upon a forward model;
d) repeating steps a) to c) with activating another one of the optical detecting units until the absorption coefficient matrices corresponding respectively to the sub-frames are obtained; and
e) configuring the diffuse optical tomography system to reconstruct the tomographic image of the target based upon the absorption coefficient matrices.

2. The image reconstruction method as claimed in claim 1, wherein the diffuse optical tomography system is configured to obtain the inverse matrix of the weight matrix using Jacobi singular value decomposition.

3. A computer program product comprising a machine readable storage medium that includes program instructions for configuring a diffuse optical tomography system to perform consecutive steps of an image reconstruction method for diffuse optical tomography according to claim 1.

4. A diffuse optical tomography system comprising:
an optical detecting device including a plurality of optical detecting units;
a processor coupled to said optical detecting device, said processor being operable to
control said optical detecting device to activate one of said optical detecting units to emit a near-infrared ray to illuminate a target, to receive a reflected light from the target, and to output a received light signal corresponding to one of a plurality of sub-frames of a tomographic image of the target, and
obtain a light intensity matrix based upon the received light signal originating from the activated one of said optical detecting units; and
a computing device including
a first computing unit coupled to said processor for receiving the light intensity matrix therefrom, said first computing unit being operable to multiply the light intensity matrix by an inverse matrix of a weight matrix to obtain an absorption coefficient matrix corresponding to one of the sub-frames, and
a second computing unit operable to provide the tomographic image of the target,
wherein said optical detecting units are activated in turns for outputting respective received light signals that are used to obtain respective light intensity matrices, said first computing unit being operable to obtain a plurality of the absorption coefficient matrices corresponding respectively to the sub-frames, said second computing unit being operable to reconstruct the tomographic image based upon the absorption coefficient matrices.

5. The diffuse optical tomography system as claimed in claim 4, wherein said computing device further includes a third computing unit operable to obtain the weight matrix based upon a forward model, and a fourth computing unit operable to obtain the inverse matrix of the weight matrix using singular value decomposition.

6. The diffuse optical tomography system as claimed in claim 5, wherein said fourth computing unit is an inverse solution module that includes:
an input/output interface adapted to receive the weight matrix from said third computing unit and to output the inverse matrix of the weight matrix;
a memory module;
a memory controller coupled between said input/output interface and said memory module, said memory controller being operable to store the weight matrix in said memory module and to access the weight matrix stored in said memory module;
at least one coordinate rotation digital computing unit (CORDIC) engine; and
a computing controller coupled between said memory controller and said CORDIC engine, said computing controller being operable to receive the weight matrix from said memory controller, to output the weight matrix to said CORDIC engine, and to control said CORDIC engine to obtain the inverse matrix of the weight matrix using singular value decomposition.

7. The diffuse optical tomography system as claimed in claim 6, wherein said fourth computing unit includes a plurality of said CORDIC engines.

8. The diffuse optical tomography system as claimed in claim 7, wherein said computing controller is operable to control parallel processing of said CORDIC engines for decomposing the weight matrix to obtain decomposed matrices from the weight matrix, and said memory module includes a plurality of memory devices for storing the decomposed matrices, respectively.

9. The diffuse optical tomography system as claimed in claim 6, wherein said CORDIC engine is configured to obtain the inverse matrix of the weight matrix using Jacobi singular value decomposition.
